(19) United States
(12) Patent Application Publication
(10) Pub. No.: US 2026/0356743 A1
(43) Pub. Date: Nov. 12, 2026

(54) ADDITIVE TEXTURING OF GLASS SUBSTRATES

(71) Applicant: CORNING INCORPORATED, CORNING, NY (US)

(72) Inventors: Jason Nelson Brown, Corning, NY (US); Theresa Chang, Painted Post, NY (US); Dillon Sands Gentekos, Newfield, NY (US); Eric Emil Leonhardt, Philadelphia, PA (US); Jianwei Liu, Painted Post, NY (US); Sean Nichols Sacks, Corning, NY (US); John Christopher Thomas, Romulus, NY (US); Shu Yuan, Vienna, VA (US)

(21) Appl. No.: 19/667,993

(22) Filed: May 5, 2026

Related U.S. Application Data
(60) Provisional application No. 63/803,088, filed on May 9, 2025.

(51) Int. Cl. C03C 17/30; C03C 17/00

(52) U.S. Cl. CPC C03C 17/30; C03C 17/009; C03C 2217/478; C03C 2218/32

(57) ABSTRACT

Embodiments of a method of forming a glass article are provided. In the method, a coating including a precursor compound is applied to at least a portion of a first major surface of a glass substrate. A first texture is imprinted into the coating, and the coating is cured to form a cured coating. The first texture defines surface features having lateral dimensions parallel to the first major surface of at least 1 μm and an average surface height of at least 50 nm. The precursor compound includes at least one of silicon, titanium, or zirconium and the cured coating includes an oxide, nitride, or oxynitride of the at least one of silicon, titanium, or zirconium.

### CROSS-REFERENCE TO RELATED APPLICATIONS

This application claims the benefit of priority under 35 U.S.C. § 119 of U.S. Provisional Application Ser. No. 63/803,088 filed on May 9, 2025, the content of which is relied upon and incorporated herein by reference in its entirety.

### FIELD

The disclosure relates to textured surfaces applied to a glass substrate and, in particular, to an imprinted texture applied to a coating on a glass substrate.

### BACKGROUND

Electronic displays are utilized in a variety of different applications, such as computers, mobile devices, and automobiles, and with the ubiquity of electronic displays, glare on displays from the sun and other light sources is an increasingly important issue. Although efficiency in light gathering and reduction of reflection and glare have been important in ophthalmic lenses and solar panels, the clarity of transmission is much less stringent in those applications than for displays. Sunlight reflecting off of a display can make readability difficult and, in some circumstances, virtually impossible. Currently, anti-glare (AG) texture or anti-reflective (AR) coatings (or a combination of the two) are used to mitigate the effects of glare. While AG texture can reduce glare from a display surface, AG textures can still be improved. For example, certain AG textures are applied in a manner that may be costly, and certain AG textures are not very robust, being easily scratched and leading to a product less usable than without an AG texture.

### SUMMARY

According to an aspect, embodiments of the disclosure relate to a method of forming a glass article. In the method, a coating comprising a precursor compound is applied to at least a portion of a first major surface of a glass substrate. A first texture is imprinted into the coating, and the coating is cured to form a cured coating. The first texture defines surface features having lateral dimensions parallel to the first major surface of at least 1 μm and an average surface height of at least 50 nm. The precursor compound comprises at least one of silicon, titanium, or zirconium and the cured coating comprises an oxide, nitride, or oxynitride of the at least one of silicon, titanium, or zirconium.

According to another aspect, embodiments of the disclosure relate to a glass article. The glass article comprises a glass substrate comprising a first major surface, a second major surface, and a minor surface. The second major surface is opposite to the first major surface, and the minor surface extends between the first major surface and the second major surface around the periphery of the glass substrate. A coating is disposed on the first major surface. A first texture is imprinted into at least a portion of the coating, and the first texture defines surface features having lateral dimensions parallel to the first major surface of at least 1 μm and an average surface height of at least 50 nm. The glass substrate comprises a first composition and the coating comprises a second composition in which the first composition and the second composition are different. The coating comprises an oxide, nitride, or oxynitride of at least one of silicon, titanium, or zirconium.

According to still another aspect, embodiments of the disclosure relate to a glass article. The glass article comprises a glass substrate comprising a first major surface, a second major surface, and a minor surface. The second major surface is opposite to the first major surface, and the minor surface extends between the first major surface and the second major surface around the periphery of the glass substrate. A coating is disposed on the first major surface. A first texture is imprinted into at least a portion of the coating, and the first texture defines surface features having lateral dimensions parallel to the first major surface of at least 1 μm and an average surface height of at least 50 nm. The coating comprises a coating composition having a chemical formula of SiOₓ in which x is in a range of 1.8 to 2.2. The glass substrate comprises a glass composition, and the glass composition is different from the coating composition.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the description serve to explain principles and operation of the various embodiments. In the drawings:

FIG. 1 depicts a flow diagram of a first embodiment of an additive method for creating a surface texture on a glass substrate, according to an exemplary embodiment of the present disclosure;

FIG. 2 depicts a high temperature cure and a low temperature cure of a silsesquioxane compound, according to exemplary embodiments of the present disclosure;

FIG. 3 is a graph of hardness as a function of depth for a cured HSQ film, a consolidated HSQ film, and an SiO₂ PVD film;

FIG. 4 depicts a flow diagram of a second embodiment of an additive method for creating a modified surface texture on a glass substrate, according to an exemplary embodiment of the present disclosure;

FIGS. 5A-5F depict SEM and laser confocal micrograph images of an antiglare glass master and a cured film defining a surface texture based on the antiglare glass master, according to an exemplary embodiment;

FIG. 6 is a graph of average surface height (Sa) for the antiglare glass master as compared to the imprinted film, according to an exemplary embodiment;

FIGS. 7A-7D depict an antiglare glass master, a first imprint of the precursor compound, a second imprint of the precursor compound performed at a higher temperature and pressure, and a thermally cured film of the first imprint, according to exemplary embodiments;

FIGS. 8A-8D depict an antiglare glass master, a negative pattern transferred to an embossing die, an imprint of the precursor compound created by the embossing die, and the imprinted precursor compound after curing, according to exemplary embodiments;

FIGS. 9A-9C depict an antiglare glass master, an imprint of the precursor compound created by a PCL embossing die, and the imprinted precursor compound after curing, according to exemplary embodiments;

FIGS. 10A-10C depict glass articles prepared using nanoimprint lithography techniques, according to exemplary embodiments;

FIGS. 11A and 11B depict graphs of cumulative height profiles for a stamp, imprints, and consolidated imprints, according to exemplary embodiments;

FIG. 12 depicts graphs of atomic species present in the consolidated film prepared using the nanoimprint lithography techniques as compared to a fused silica standard, according to exemplary embodiments of the present disclosure; and

FIG. 13 depicts cumulative height fraction for a stamp and an imprint (replica) according to exemplary embodiments.

### DETAILED DESCRIPTION

Reference will now be made in detail to various embodiments of a glass article having a glass substrate coated with a cured film that has been imprinted with a texture, examples of which are illustrated in the accompanying drawings. As will be discussed more fully below, the presently disclosed film is prepared through an additive process in which a coating is applied to a glass substrate, imprinted with a texture, cured, and optionally consolidated at elevated temperature. Current processes to produce textures on glass substrates are done via a subtractive or etching-based process, which has limitations with respect to available feature sizes and aspect ratios. Applicant has found that the presently disclosed films and processes or forming same provide a wide range of lateral feature sizes and can be formed at depths of up to 1 micron without fillers and even greater than 1 micron when fillers are utilized. As will be appreciated from the following discussion, Applicant believes that much thicker films of unfilled silicon oxide (SiOₓ) are able to be achieved according to the presently disclosed process than previously known in the art. Besides this improvement in widening the design window, the presently disclosed additive method of applying the textured film is more cost effective and environmentally friendly than conventional methods. These and other aspects and advantages of the disclosed glass article with textured film and method of manufacturing same will be described in relation to the embodiments provided below and depicted in the drawings. These embodiments are presented by way of example and not by way of limitation.

To reduce glare on electronic displays having glass covers, acid-etching is conventionally employed to provide an antiglare (AG) texture. In contrast to antireflective (AR) coatings, which rely upon refractive index differences to reduce total reflection, AG textures are based on surface features of certain geometries to scatter light and blur the image being reflected so that the viewer is less distracted by the reflected image on the surface of the display. Conventionally, AG textures are applied to glass surfaces using acid etching techniques, usually with an etch resist pattern (such as polystyrene particles, printed ink, etc.), to etch the glass surface. Commonly, the glass is etched using hydrofluoric (HF) acid, often in conjunction with other acids or additives, which poses safety and containment challenges for manufacturing in addition to the costs of maintaining etch tanks and disposing of waste when the etch bath is exhausted.

Further, acid etch on one surface of the glass sheet produces a glass surface having a slightly different surface composition, surface area, and roughness compared to the other side of the glass sheet. This can create challenges in the manufacture of glass meant for chemical tempering. After undergoing chemical tempering to induce surface compressive stresses, the differences in compressive stress on opposing sides of the glass may create a bow in the glass sheet, which then has to be resolved in post treatment, adding complexity and cost to the manufacturing process.

Another way to make AG texture on the surface of glass is to use micro-replication/imprinting with a polymer resin. However, the low modulus and low hardness of polymeric materials (even composites) make the scratch and chemical resistance of the texture relatively poor.

According to the present disclosure, the surface texture, such as an AG surface texture, is formed using a ceramic precursor, such as a solution processable oxide, nitride, or oxynitride. Examples of such ceramic precursors include silsesquioxanes (e.g., hydridosilsesquioxane (HSQ), and polyhedral oligomeric silsesquioxane (POSS)), perhydropolysilazane (PHPS), or organometallics (such as organo titanates, zirconates, or borates (e.g., Tyzor®, available from Dorf Ketal Chemicals (India) Pvt. Ltd., Mumbai, India). As will be discussed below, the ceramic precursor is coated onto the surface of a glass substrate, imprinted with a texture (e.g. using a stamp), cured, and then optionally consolidated to provide a surface texture film on the glass substrate. In this way, surface textures are applied to a glass substrate using an additive technique and without requiring acid etching. While the following discussion will be described primarily in relation to antiglare (AG) surface textures, the disclosure should be read as encompassing other surface textures provided on glass, such as diffraction gratings, antireflection coatings, and glass hard coats, amongst other possibilities.

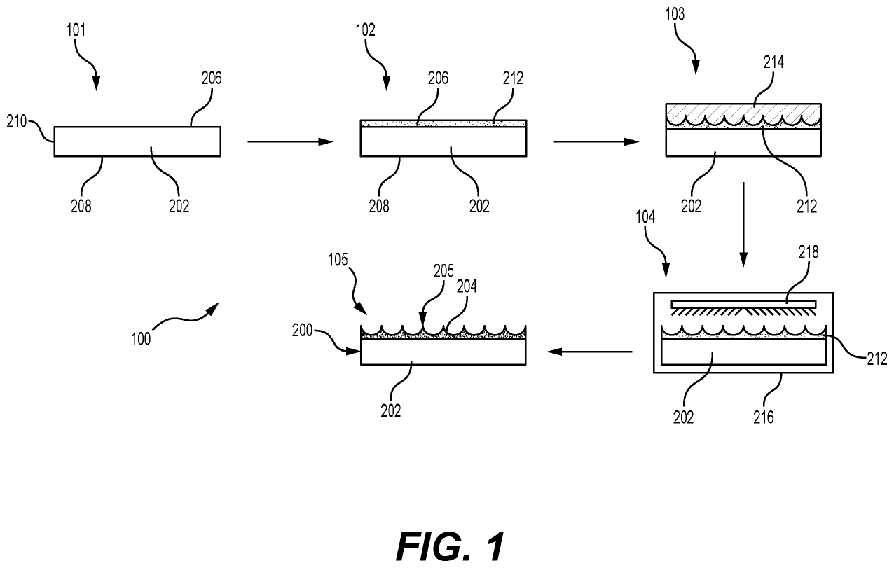

FIG. 1 depicts an exemplary embodiment of a method 100 for preparing a glass article 200 comprising a glass substrate 202 having a film 204 defining a surface texture 205. As will be discussed more fully below, the glass substrate 202 comprises a first composition, and the film 204 comprises a second composition that is different from the first composition. For example, the first composition of the glass substrate 202 may be an alkali aluminosilicate or alkaline earth boro-aluminosilicate, and the second composition of the film 204 may be an oxide, a nitride, an oxynitride, or metal counterion of at least one of silicon, titanium, or zirconium.

In the method 100, the glass substrate 202 is selected in a first stage 101. The glass substrate 202 includes a first major surface 206 and a second major surface 208. In one or more embodiments, the surface texture 204 is applied to one of the first major surface 206 or the second major surface 208, but in one or more other embodiments, the surface texture 204 is applied to both the first major surface 206 and the second major surface 208. The first major surface 206 and the second major surface 208 are connected by a minor surface 210 around the periphery of the glass substrate 200. The glass substrate 200 is not particularly limited in terms of the glass composition or thickness. Examples of glass compositions suitable for use as the glass substrate include alkaline earth boro-aluminosilicate glass (e.g., EAGLE XG® glass, Astra™ glass, and Lotus™ NXT glass, each available from Corning Incorporated, Corning, NY) and alkali aluminosilicate glass (e.g., Gorilla® glass available from Corning Incorporated, Corning, NY). Typical glass thicknesses for the glass substrate may be in the range of 0.03 mm to 5 mm.

In a second stage 102, at least a portion of at least one of the first major surface 206 or the second major surface 208 is coated with a precursor compound 212. In one or more embodiments, the precursor compound 212 comprises at least one of silicon, titanium, or zirconium and is configured to form an oxide, nitride, or oxynitride of the at least one of silicon, titanium, or zirconium upon curing and/or consolidating. In one or more embodiments, the precursor compound 212 comprises at least one of silicon, titanium, or zirconium and a metal counterion. As mentioned above, the precursor compound 212 may be, for example, a silsesquioxane (such as HSQ and POSS), a PHPS, or an organometallic, amongst other possibilities. The precursor compound 212 can be coated on the glass substrate 200 in a variety of different ways, including spin coating, spray coating, dip coating, or vapor deposition, for example. During coating, the solvent in the precursor compound 212 is evaporated, leaving a waxy material to be cured or crosslinked.

In one or more embodiments, depending on the feature shape and size to be imprinted, nanoparticles can be incorporated into the precursor compound 212 to adjust for refractive index. For example, addition of hollow silica particles or organic materials of lower refractive index (or fugitive pore formers) can lower the refractive index of the resultant film 204. By contrast, incorporation of, e.g., titania nanoparticles can increase the refractive index. Additionally, if light scattering properties are desired, materials of contrasting refractive index can be selected having visible size (100 nm or above).

If surface hydrophobicity is desired, the precursor compound 212 can include a hydrophobic molecule (e.g., methyl oleate amongst other surfactants known in the art) designed to remain in the surface texture after curing. Such hydrophobic molecules may help improve cleaning capability, comparable to an easy-to-clean (ETC) coating, in particular for such applications as solar panels (allowing for easier removal of dust or other particulates on the surface) and touch screens (providing anti-fingerprint or anti-smudge properties). With respect to touch displays, the ability to modify the amount of remaining hydrophobic molecules on the surface can also provide the capability of changing the tactile feel of the display. That is, if a more slippery feel is desired, a higher concentration of hydrophobic molecules could be maintained on the surface, and if a rougher feel is desired, a lower concentration of hydrophobic molecules or no hydrophobic molecules may be allowed to remain on the surface after curing.

In one or more embodiments, the precursor compound 212 comprises from 20 wt % to 90 wt % of the component comprising at least one of silicon, titanium, or zirconium, 2 wt % to 20 wt % of a monomer component, up to 60 wt % of a solvent, up to 10 wt % of an organo titanate, borate, or zirconate, up to 40 wt % of a filler compound, and up to 3 wt % of a photoinitiator.

In a third stage 103, the precursor compound 212 is imprinted with a texture using an embossing die 214. In one or more embodiments, the embossing die 214 is prepared by molding a material against a master form having the desired surface texture. For example, if the embossing die 214 is desired to impart an AG surface texture, the embossing die 214 can be prepared by molding a material against a glass substrate 202 having the desired AG surface texture. In one or more embodiments, the molding material used for the embossing die 214 comprises a silicone (e.g., polydimethylsiloxane (PDMS)), a fluoropolymer (e.g., a perfluoropolyether (PFPE)), a polyester (e.g., polycaprolactone (PCL)), or a polyacrylate.

Further, in one or more embodiments, the embossing die 214 can be treated or machined into a metal, glass, or ceramic material to have the desired surface texture. For example, instead of a random texture produced by acid etching, the surface texture can have an engineered geometry produced using one or a combination of computer design, 3D printing, lithography, printing, polishing, etc. to produce features of different shapes and sizes to achieve the coating performance attributes.

The embossing die 214 will have the reverse or negative topology of the surface texture desired to be imprinted into the precursor compound no matter how the embossing die is prepared. During the stage of imprinting, the embossing die 214 may, in one or more embodiments, apply a pressure in a range from 10 psi to 120 psi (e.g., from 20 psi to 120 psi, from 20 psi to 110 psi, form 30 psi to 100 psi, from 40 psi to 90 psi, or from 50 psi to 80 psi). In one or more embodiments, the embossing die 214 applies the pressure for a time of up to 10 minutes, in particular in a range of 0.5 minutes to 10 minutes, for example. In one or more embodiments, the imprinting stage 103 is performed at a temperature in a range of 20 °C to 200 °C, in particular in a range of 20 °C to 100 °C. In one or more embodiments, the imprinting can be performed manually (e.g., pressing the embossing die 214 by hand or using forceps) or automatedly (e.g., using a roll or a stamping apparatus, such as nanoimprinter). In embodiments, the pressure, pressing time, and pressing temperature during the stage of imprinting can be greater and/or lesser than indicated herein depending on the composition of the precursor compound.

The surface texture imparted by the embossing die 214 can have a wide variety of topologies with lateral features sizes of, e.g., 1 micron or greater, 25 microns or greater, or even 100 microns or greater. As used herein, the lateral size of a feature is a width or length dimension of the feature measured parallel to the nearest first or second major surface 206, 208 of the glass substrate 202. The surface texture imparted by the embossing die 214 may have an average surface height (Sa) as measured according to ISO 4287 of at least 50 nm, at least 75 nm, at least 100 nm, or at least 125 nm. In one or more embodiments, the surface texture imparted by the embossing die 214 imparts features having a depth of up to 1 micron (the depth being the size dimension perpendicular to the length and width). Notwithstanding, the depth of the surface feature may be made greater than 1 micron, in particular, if fillers are used in the precursor compound. Examples of suitable fillers includes colloidal silica, fumed silica, precipitated silica, silica gel, glass fiber and glass beads (where the stamp features are larger than the individual or agglomerated fillers), colloidal zirconia, titania, alumina, other oxides, and nano-crystalline materials, such as ceramics. In one or more embodiments, the precursor compound comprises up to 10 wt %, up to 20 wt %, up to 30 wt %, or up to 40 wt % of fillers.

In one or more embodiments, besides allowing for greater feature depth, the fillers may be used to enhance the fidelity of the imprinted surface texture relative to the reference texture from the master. That is, the coating of the precursor compound 212 may slump or flow after the embossing die 214 is removed. The filler can be used to help maintain the structure of the imprinted coating against such slumping or flowing.

Notwithstanding, the coating of the precursor compound 212 may not flow enough under the pressure of the embossing die 214, especially to provide the desired sharpness of features, and thus, in one or more embodiments, the precursor compound 212 is provided with a flow agent to decrease the viscosity of the coating. Examples of suitable flow agents include liquid paraffin wax, hexadecane, methyl oleate, long chain alkanes (>C10), fatty acids, fatty acid esters, hydroxyethyl methacrylate, bisphenol A dimethacrylate, and any other compounds that provide low vapor pressure and do not phase separate with the precursor compound 212.

In general, the imprinting stage 103 is dependent on the pressure applied by the embossing die 214 on the precursor compound 212 in that higher pressures result in greater extent of pattern transfer. It is also desirable to control the uniformity with which the pressure is applied, especially across large surfaces. As mentioned above, two possibilities that provide more uniform application of pressure are a nanoimprinter system (e.g., Nanonex imprinter), which applies pressuring using an air bladder, and a tunable roller.

For textured surfaces that are random in design, though, defect tolerances may be greater, allowing for a lesser degree of uniformity. For designs where a high degree of uniformity of pressure is not needed, a design of the embossing die 214 for the stage of imprinting 103 may be akin to a rubber stamp in that, upon application of pressure, compliant material behind the embossing die 214 would to some extent equalize the pressure being applied. In the context of a roller, the compliant material could be in the form of a roller with the surface texture to be transferred on the outer surface area of the roller. The roller design provides for imprinting of much larger surface areas, and because the roller provides line contact with the precursor compound 212, pressure only needs to be controlled in one dimension instead of two dimensions as is the case for pressure across a larger surface area.

In a fourth stage 104, the precursor compound 212 is cured. In FIG. 1, the glass substrate 202 with precursor compound 212 is shown schematically in a chamber 216 with a curing element 218 (e.g., a thermal element or radiative element). Curing can be accomplished using a variety of techniques, including thermal cure, ultraviolet light cure, e-beam cure, and plasma cure, amongst other possibilities. In one or more embodiments, the thermal cure may be a high temperature cure, performed at a temperature of at least 350 °C for a time in a range from 30 minutes to 90 minutes (e.g., 400 °C for about 30 minutes). In one or more embodiments, the thermal cure may be a low temperature cure, performed at a temperature of below 350 °C, in particular in a range of 100 °C to 200 °C for a time in a range from 30 minutes to 150 minutes. In one or more embodiments, the low temperature cure is performed using a catalyst, in particular a base catalyst (e.g., having the general form of H₂NR, such as hexylamine).

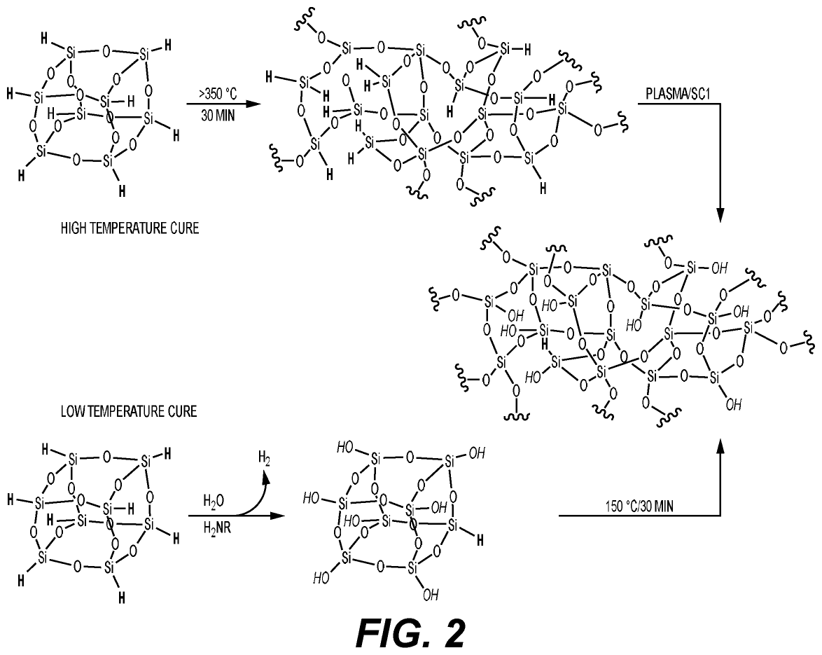

In one or more embodiments involving silsesquioxane precursor compounds, the curing results in the formation of a film 204 of amorphous silica. In one or more embodiments, the amorphous silica has the formula SiOₓ in which x is in the range of 1.8 to 2.2, which accounts for, e.g., any incomplete reaction of the pendant groups of the silsesquioxane compound, such as HSQ or POSS, or the presence of modifiers and/or contaminants. FIG. 2 depicts two thermal pathways to curing a silsesquioxane precursor compounds, in particular HSQ, using the high temperature path and the low temperature path using base catalysis.

Further, in one or more embodiments, the imprinting and curing stages 103, 104 may be performed together, such as in a nanoimprint lithography technique.

Upon curing, the surface features will substantially be locked into their topology.

Depending on the method of curing and the use or absence of fillers and/or flow agents, a variety of process controls are provided to enhance or diminish the sharpness of the imprinted features to achieve desired performance of the textured surface. For example, if a POSS precursor compound was cured using plasma or e-beam treatment, then the imprinted surface texture will largely be faithfully reproduced. However, if a thermal cure is used along with a flow agent, then the features can be made less sharp. Moreover, within the thermal cure, surface texture can further be controlled by manipulating one or more of the temperature of cure, the ramp rate for heating to the temperature of cure, and the thermal stability (volatility) of the flow agent. Still further, base catalysis can be used in conjunction with a thermal cure to reduce the required curing temperature, thereby decreasing the amount of resin reflow.

The ability to manipulate the sharpness of the surface texture enhances the control over the optical effect and durability of the surface texture. For certain applications, it may be desirable to increase the sharpness to enhance the optical effect of the surface texture, but in other applications, it may be more desirable to decrease the sharpness to enhance the abrasion durability of the surface texture. The curing parameters described above provide a spectrum of control to achieve the desired balance of pattern transfer/fidelity, optical effect, and durability for any of a variety of applications in which the surface texture is employed. For example, Applicant has found that flattening the peaks of AG surface texture to plateaus (e.g., through abrasion techniques) can dramatically improve cheesecloth abrasion durability (ISO 92211-4:2022 (E)). Through the presently disclosed process, surface textures with improved abrasion durability can be molded onto an embossing die to imprint directly onto a precursor compound over and over in a reproducible manner, or a base surface texture pattern can be manipulated through an optimized cure process to result in the desired pattern in a manner that is consistently reproducible.

In one or more embodiments, the method 100 optionally includes a consolidating stage 105 in which the cured film 204 is heated to a temperature at which substantially all remaining organics are pyrolyzed and the cured film 204 is sintered. In one or more embodiments, the consolidating stage is performed at a temperature of up to 1000 °C, in particular at a temperature of 650 °C or less. In one or more embodiments, the consolidating stage is performed at a temperature of at least 500 °C. In one or more embodiments, consolidating can be used to increase the modulus and hardness of the film 204 on the glass substrate 202.

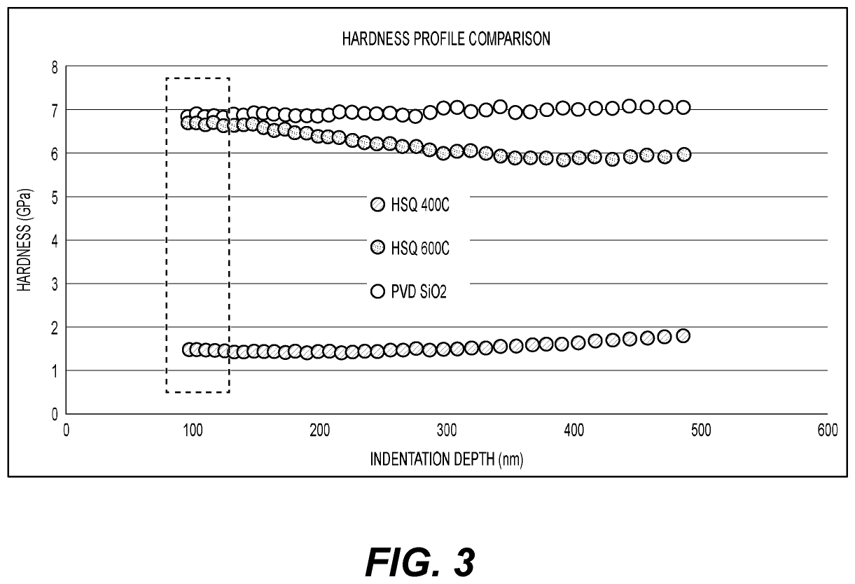

For example, a film 204 of HSQ that is cured at 400 °C was measured to have a modulus of 9.4 GPa and a hardness of 1.4 GPa. By contrast, a film 204 of HSQ that was consolidated at 600 °C was measured to have a modulus of 56.5 GPa and a hardness of 6.8 GPa. As a comparison, a film of SiO₂ was deposited on a glass substrate using physical vapor deposition (PVD) and was measured to have modulus of 62.3 GPa and hardness of 6.9 GPa. FIG. 3 provides a graph of measured hardness as a function of indentation depth. As can be seen, the hardness of the consolidated HSQ at the surface of the film is substantially the same as the PVD SiO₂, but as the depth of indentation increases, the hardness of the consolidated HSQ deviates from the hardness of the PVD SiO₂ by up to about 1 GPa at a depth of 500 nm. Notably, the hardness of the PVD SiO₂ does not change substantially over the measurement depth, and the hardness of the consolidated HSQ decreases as depth increases. Further, as can be seen in FIG. 3, the hardness of the cured HSQ increases as the depth increases.

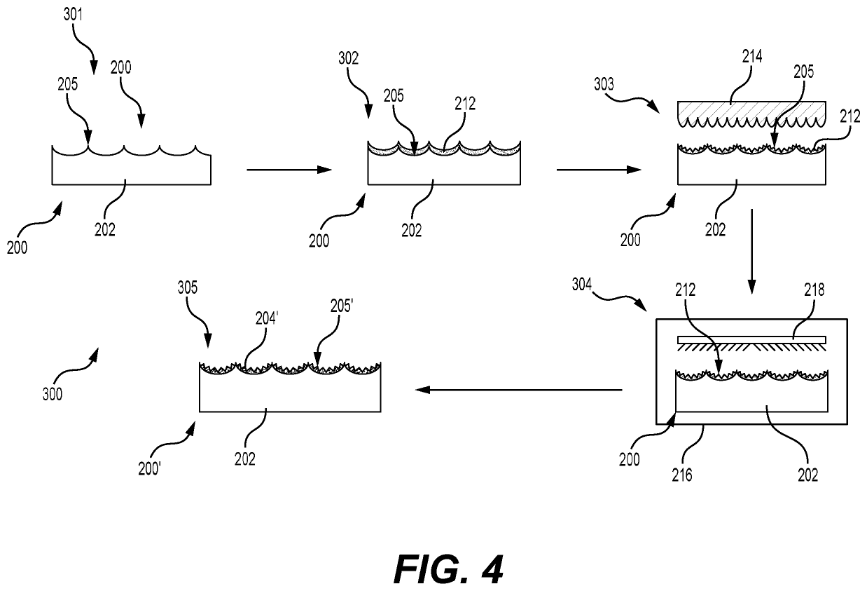

Referring now to FIG. 4, an exemplary embodiment of a method 300 to stack surface textures is depicted. As can be seen in FIG. 4, in a first stage 301 of the method 300, a glass article 200 comprising a glass substrate 202 with a surface texture 205 is provided. The glass article 200 may be either a glass article 200 formed as described above in relation to the method of FIG. 1, or the glass article 200 may be a glass substrate 202 acid-etched or otherwise surface treated to provide a surface texture 205. In a second stage 302 of the method 300, the precursor compound 212 is applied to the textured surface 205 using any of the previously described coating techniques, such as spin coating, spray coating, dip coating, or vapor deposition, for example. Thereafter, in a third stage 303, an embossing die 214 is pressed into precursor compound 212 to impart a second surface texture. In embodiments, the second surface texture is different than the first surface texture such that the second surface texture modifies the first surface texture. For example, the first surface texture may have larger surface features (e.g., longer lateral dimensions and/or deeper depths) than the surface features of the second surface texture. In this way, pressing the second surface texture onto the first surface texture may impart finer features into the precursor compound 212. In embodiments, the pressure, pressing time, and/or pressing temperature in the third stage 303 can be the same as or different than those described above in relation to the method of FIG. 1. In a fourth stage 304, the textured precursor compound 212 is cured according to any of the curing techniques described above. As shown in FIG. 4, the glass article 200 is disposed in a curing chamber 216 with a curing element 218 as described above. As shown in a fifth stage 305, the glass article 200 is transformed to a modified glass article 200′ with a film 204′ defining a new surface texture 205′ that is a combination of the first surface texture and the second surface texture. Additionally, the cured film 204′ may be further consolidated at high temperature as discussed above. In principle, there is no practical limit on the number of films with different surface textures that can be applied to the surface of the glass substrate to produce.

The stacking of surface textures allows for the creation of features that would be difficult or impossible to make using conventional subtractive techniques, such as etching. Further, compared to these standard techniques, stacked features could be tuned (relative size of features, spacing between features, etc.) to better control optical properties, such as specular reflectance, scattered light angles, and scattered light intensity.

Advantageously, the presently disclosed additive method of applying surface texture to a glass substrate provides durability in coating robustness as demonstrated in abrasion tests, including involving surfaces with fluoroether silanes coatings. Further, the applied surface texture exhibits good adhesion to and chemical compatibility with the glass substrate. The surface modification process is versatile, allowing for a wide range of surface topographies and textures to be consistently replicated, and can be prepared from a large library of commercially available precursors using known coating and curing techniques. Additionally, the presently disclosed methods do not require the use of HF or associated etchant tanks, and the presently disclosed methods, which can be conducted after chemical strengthening, avoid the issue of glass warping caused by differential surface compression of the ion exchanged glass surface. Further, the disclosed methods can be made continuous through use of spray coating, roller imprinting, and continuous curing chambers.

### EXPERIMENTAL EXAMPLES

### Example 1—Imprinting of HSQ

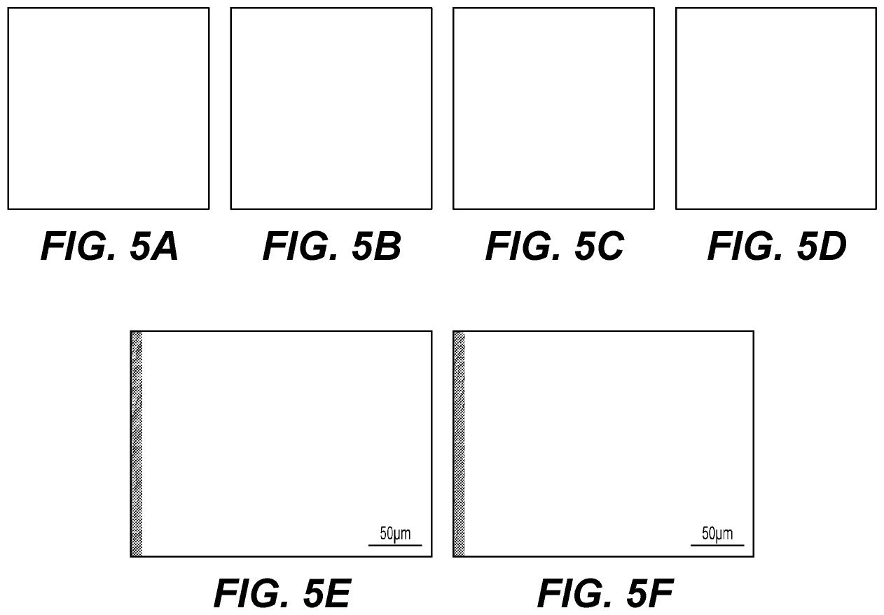

An embossing die, in particular a stamp, was cast from a pre-existing antiglare (AG) glass produced by acid etching. The stamp was cast from polydimethylsiloxane (PDMS). Before casting the stamp, the AG surface of the glass was cleaned using oxygen plasma treatment followed by coating with (tridecafluoro-1,1,2,2-tetrahydrooctyl) trichlorosilane under vacuum as the release agent. The AG surface from the glass master was imaged using SEM, and images of the AG surface are shown in FIGS. 5A and 5B as imaged using full BSD and topography BSD, respectively. Thereafter, 50 g PDMS prepolymer and 5 g curing agent (Sylgard™ 184, Dow Chemical) were thoroughly mixed in the weight ratio of 10:1 and degassed in vacuum to remove air bubbles. Next, the PDMS prepolymer mixture was poured onto the AG glass master and cured at room temperature in an oven for 48 hours. The PDMS stamp was then peeled off from the AG glass master.

HSQ (25 wt %) was spun coat onto 2″×2″ glass at 1200 rpm for 30 seconds. The coating was intentionally not dried (although evaporation was uncontrolled) so that the residual solvent could be used to act as a flow aid/plasticizer for the imprinting stage.

For imprinting with the PDMS stamp, imprinting was performed by placing the PDMS stamp into the spun-coat HSQ layer with a nanoimprinter (NX-2500 available from Nanonex, Corp., Monmouth Junction, NJ) at a pressure of 80 psi and temperature of 150 °C for 2 min.

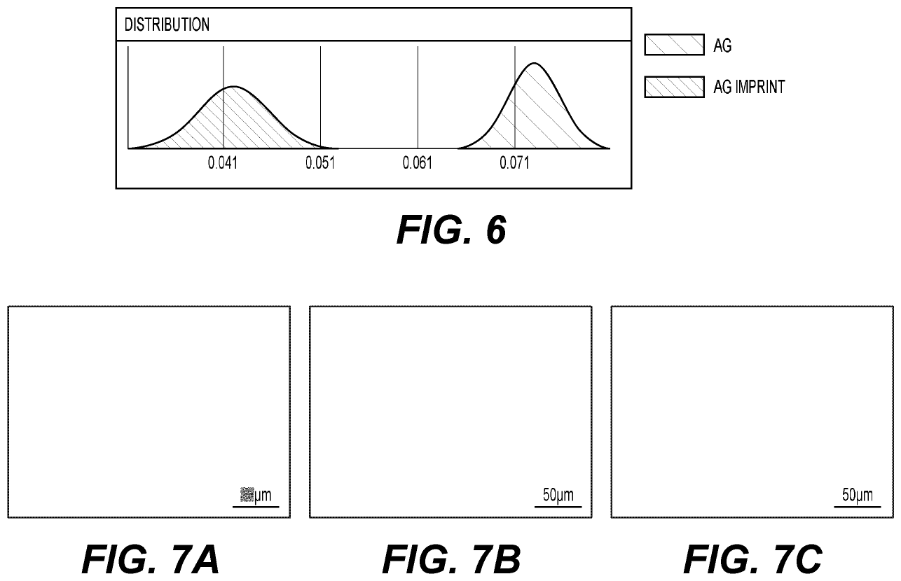

The imprinted features were imaged with SEM, and the full BSD and topography BSD images are shown in FIGS. 5C and 5D, respectively. Additionally, the AG surface from the glass master and the imprinted HSQ surface were imaged using laser confocal microscopy as shown in FIGS. 5E and 5F, respectively, to illustrate that the resulting imprinting features duplicated the lateral features faithfully. There was some flattening of the vertical topography when comparing the HSQ AG coating to the AG glass master. In particular, the arithmetic mean height of the surface (Sa) of the AG glass master was 71 nm, and the arithmetic mean height of the surface (Sa) of the HSQ imprinted surface was 41 nm with a moderately broader surface height distribution as shown in graph of FIG. 6.

### Example 2—Imprinting HSQ-Controlling Pattern Fidelity-Stamp Modulus

In Example 1, the stamp material was PDMS, which has a relatively low modulus, which may deform under pressure. As a result, a PFPE mold material was used to see if it is possible to improve the pattern fidelity to understand the potential limitations of stamp modulus for imprinting. In order to make the PFPE stamp, the AG glass master was prepared as described in Example 1. An ultraviolet (UV) curable fluoroether urethane acrylate mold resin was placed on the AG master and pressed with a PET backing material and then subjected to UV exposure of 3000 mJ/cm². After UV curing, the PFPE stamp is released from the master wafer together with PET backing.

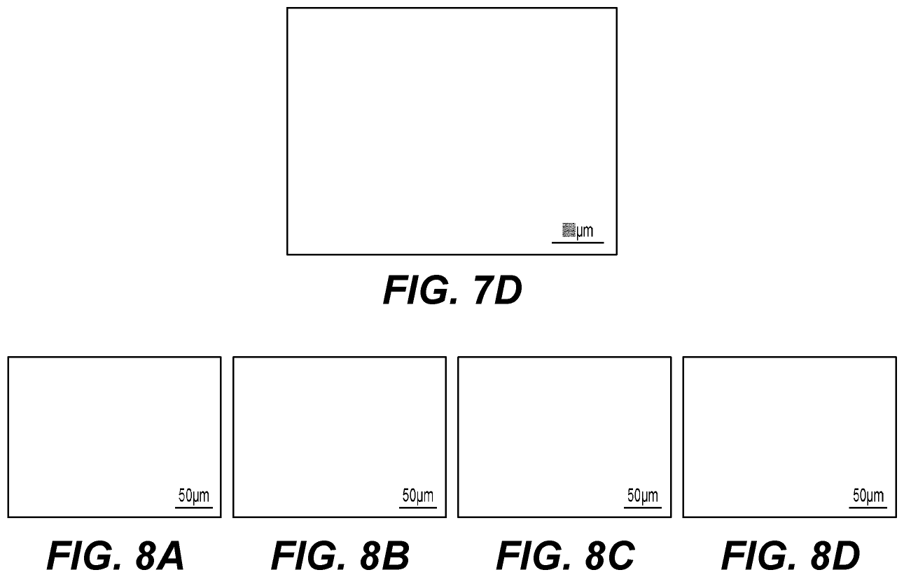

FIGS. 7A-7D depict the AG glass master (FIG. 7A), a first imprint at 80 psi (FIG. 7B), and a second imprint at higher temperature (75 °C to 100 °C) (FIG. 7C), and the first imprint after a high temperature cure (FIG. 7D). Upon imprinting as described in Example 1, the PFPE stamp was able to imprint the HSQ with ~ 90% pattern fidelity based on surface height Sa as shown in FIG. 7C using the higher temperature. At the same pressure of 80 psi as Example 1 using the PDMS stamp, the imprinted pattern had slightly better fidelity (64.1% vs. 57.7% based on surface height Sa) as shown in FIG. 7B. FIG. 7D depicts the first imprinted surface texture after curing at 400 °C for 30 minutes. Based on the average surface height (Sa) of 0.099 μm, the pattern fidelity was 47.4% relative to the AG glass master. Based on the results of Example 2, Applicant believes that pattern fidelity could be further adjusted by changing the imprinting temperature, stamp material, or an additive to improve flow (as described in the additional examples below).

### Example 3—Process Broadening Utilizing Flow Aid/Plasticizer

HSQ and other POSS materials are not polymeric and exist as distinct, discrete structures. Therefore, HSQ does not exhibit mechanical entanglement prior to curing (thermal, UV, or otherwise). As such, in the absence of solvents or additives to improve flow, POSS materials (depending on side chain) would inherently have compliance given weak enough forces between the oligomeric units. In the range of POSS materials that are commercially available, there is a range of material from free flowing (R=PEG, R=acrylate or methacrylate), to waxy (R=H (i.e., HSQ); R=isobutyl, R=glycidyl, etc.) to completely immovable (ionized versions). It is possible to select a POSS or related material for its inherent material property, but in the cases where the side chains are important for functionality, an additive could be used to assist in the flow of the POSS material under shear.

For example, with HSQ or other highly hydrophobically modified POSS, it is possible to use long chain hydrocarbons (such as liquid paraffin wax, hexadecane) to promote flow under ambient conditions. In addition, it is also feasible to use paraffin wax of sufficient melting temperature to promote flow upon thermal treatment, but freeze the structure upon lowering of the substrate/coating temperature. The addition of the flow aid would necessitate removal prior to curing of the oxide resins, so that the surface features are not lost upon cure.

### Example 4—Ambient HSQ Imprinting Using Flow Agent

It is generally desirable to imprint at standard temperature and pressure to avoid the cost and complexity of imprinting at elevated temperature and/or pressure. Thus, Applicant investigated the use of a flow agent to assist with the imprinting of the coating. In particular, Applicant added a flow agent to the HSQ coating (FOX-25 available from Dow Corning,) to promote flowability of the coating for imprinting. Methyl oleate was chosen for the flow agent because of its compatibility/miscibility with HSQ as well as its low vapor pressure, which allows for selective evaporation of the HSQ solvent prior to imprinting, resulting in the ability to control the quantity of flow agent. Using 7 wt. % methyl oleate (99%) in the HSQ, samples were imprinted and cured on 2″×2″ glass (Eagle XG® available from Corning Incorporated, Corning, NY).

In particular, a stamp formed from polycaprolactone (PCL) was prepared from the AG glass master (HF acid etched) shown in FIG. 8A. The AG glass master had an average surface height (Sa) of 0.179 μm. The PCL stamp is shown in FIG. 8B, and as can be seen there, the PCL stamp provides a high fidelity negative of the AG glass master surface. Indeed, the average surface height (Sa) was 0.177 μm, which is 98.9% fidelity.

The HSQ coating was applied to the glass, and the HSQ coating was imprinted by hand using the PCL stamp secured to forceps. The HSQ coating as imprinted and before curing is shown in FIG. 8C. The imprinted HSQ coating had an average surface height (Sa) of 1.62 μm, which is 90.5% fidelity to the AG glass master. The imprinted HSQ coating was cured with hexylamine at 150 °C for 1 hour (30 minutes in the presence of water, 30 minutes without water). The cured HSQ coating is shown in FIG. 8D, which had an average surface height (Sa) of 0.153 μm (85.5% fidelity). From Example 4, it can be seen that a high texture fidelity can be achieved in ambient conditions when imprinting by hand for AG feature sizes of ~10-25 μm. Further, as compared to the high temperature cure of Example 2 (FIG. 7D), the low temperature cure of the present example resulted in less resin reflow and provided a greater pattern fidelity.

### Example 5—Designed Imprinting Features

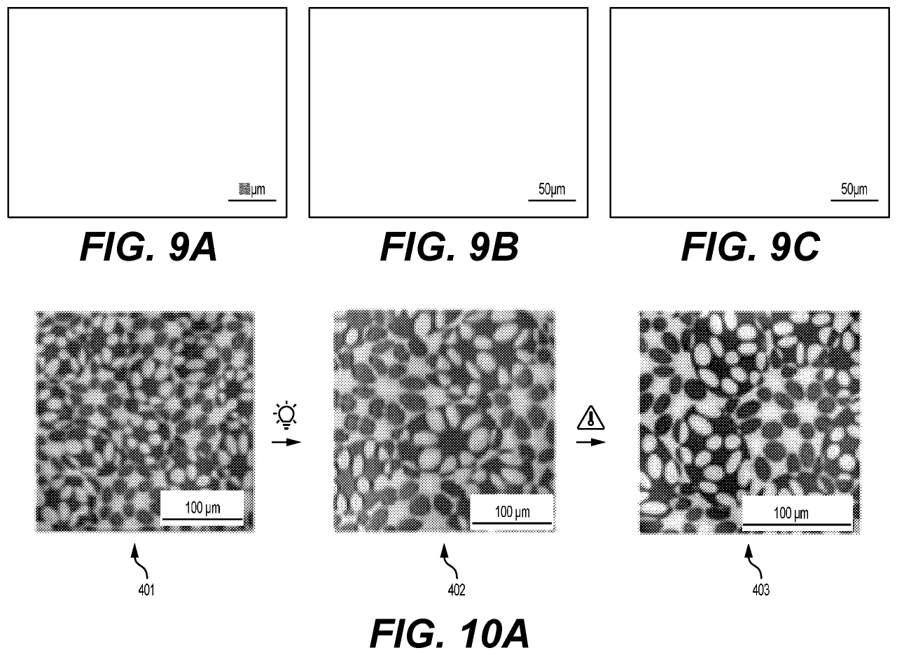

Samples were also imprinted using an automated roller process tuned to apply high pressure at slow speeds. The samples were imprinted with AG features having sizes between ~5-10 μm. The AG glass master is shown in FIG. 9A and exhibits an average surface height (Sa) of 0.175 μm. The PCL stamp is shown in FIG. 9B and exhibits an average surface height (Sa) of 0.180 μm (or 102.9% fidelity relative to the AG glass master, implying extra texture was applied to the surface of the stamp). As mentioned, the PCL stamp was pressed against a coating of HSQ using an automatic roller, which had a roll diameter of 10 inches, applied 112 psi, and operated at a roller speed of 0.1 mm/s, at ambient temperature and pressure. The HSQ coating was cured with hexylamine at 150 °C for 1 hour (30 minutes in the presence of water, 30 minute without water), and the cured HSQ coating is shown in FIG. 9C. The average surface height (Sa) was 0.163 μm, which is a fidelity of 93.1%.

While pattern fidelity has been characterized using surface height (Sa), there are other parameters relevant for characterizing the surface texture. For example, some performance specifications include but are not limited to:
1) sparkle (measured as pixel power deviation (PPD)), desirably (PPD-140)<7%, in particular <5%
2) haze, desirably <20%, in particular <10%,
3) distinctiveness of image (DOI), desirably <90, in particular <80, and most particularly <70, as measured using SMS-1000 (Display-Messtechnik&Systeme (Rottenburg Am Neckar, Germany);
4) specular reflectance, desirably <2%, in particular <1%, and most particularly <0.5% and
5) gloss (e.g. 60° gloss), which can depend on the particular application and desires strength of the AG surface, amongst other relevant specifications.

Additionally, surfaces may have a targeted RMS roughness in the range of 50-250 nm, and at least some characteristic lateral surface feature sizes (some surface spatial periods, which is the inverse of surface spatial frequency content) in the range of 5-75 microns. Various other surface roughness values may also be used to characterize the surface texture, including Ra (average distance between peaks and valleys on a surface), RMS (root mean square height, which is the standard deviation of heights), Spc (arithmetic mean peak curvature of the peaks on the surface), Sdq (root mean square gradient, which is the calculated root mean square of slopes at all points in the definition area), RSm (mean width of profile elements, representing the average horizontal width of peaks and valleys in the surface profile), and Pitch (distance or spacing between individual peaks and valleys within the roughness profile). In one or more embodiments, the roughness parameters are measured according to ISO 4287, e.g., using a profilometer.

Given the high fidelity in pattern reproduction, Applicant expects that the base catalyzed cure process will be capable of maintaining AG texture as well as crosslinking the HSQ material. The results suggest that the imprinted samples shown in FIG. 9C have similar AG properties compared to other AG textures currently produced by mechanochemical etching. Further, Applicant believes that various processing techniques can be used to enhance the fidelity of the imprinted AG texture, such as applying the precursor compound in a cleanroom with standard environmental controls. Still further, pressing conditions for different surface texture are expected to be optimized. By enhanced control over these processing conditions, Applicant expects that even greater fidelity can be achieved.

### Example 6—UV Cured AG Coating

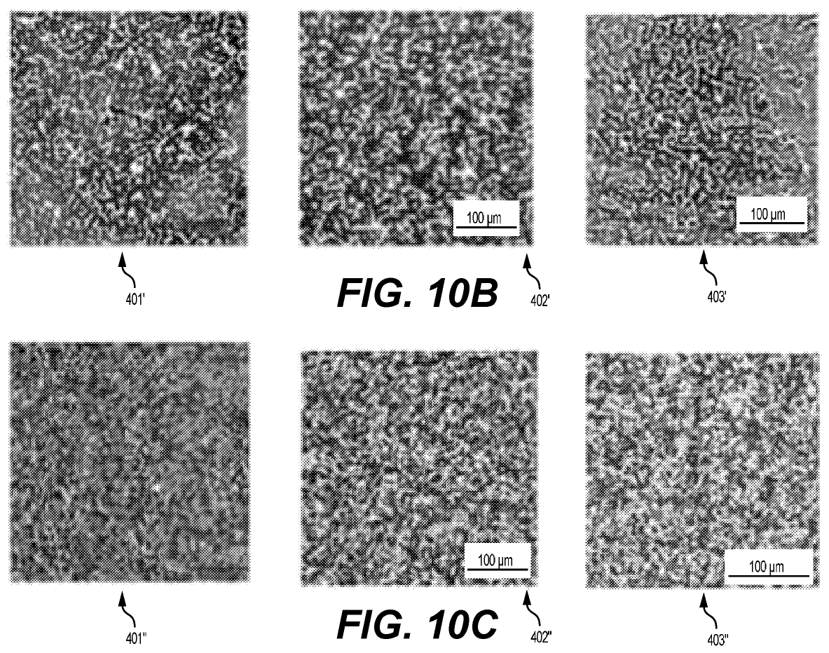

POSS resins with pendant organic functional groups (acrylate groups) were prepared to provide a photocurable composition. As will be discussed below, the organic portion of the POSS resin was pyrolyzed so as to deposit a fully inorganic SiOₓ coating on the glass substrate. FIG. 10A depicts an AG glass master 401 from which a silicone stamp was prepared. The AG glass master was a 4 level texture produced by four photolithography/etching steps, essentially producing a stack of four textures. The silicone stamp pattern was transferred to a POSS resin 402, and the imprinted resin was cured using UV light. Thereafter, the POSS resin was consolidated by heating the POSS resin to sinter it into fused silica 403. The POSS resin was consolidated from room temperature to 300 °C on a hot plate and then heated to 600 °C and held for 2 hours. Thus, a 4 level texture was reproduced on a glass substrate by imprinting on POSS resin in a single step.

FIG. 10B depicts another AG glass master 401′ from which a silicone stamp was prepared. The AG glass master 401′ was also a 4 level texture. The silicone stamp pattern was transferred to a POSS resin 402′ comprising an organotitanium compound, and the imprinted resin was cured using UV light. Thereafter, the POSS resin was consolidated by heating the POSS resin to sinter it into fused silica 403′. The POSS resin was consolidated from room temperature to 300 °C on a hot plate and then heated to 600 °C and held for 2 hours.

FIG. 10C depicts a third AG glass master 401″ from which a silicone stamp was prepared. The AG glass master 401″ was also a 4 level texture. The silicone stamp pattern was transferred to a POSS resin 402″ comprising a colloidal silica, and the imprinted resin was cured using UV light. Thereafter, the POSS resin was consolidated by heating the POSS resin to sinter it into fused silica 403″. The POSS resin was consolidated from room temperature to 300 °C on a hot plate and then heated to 600 °C and held for 2 hours.

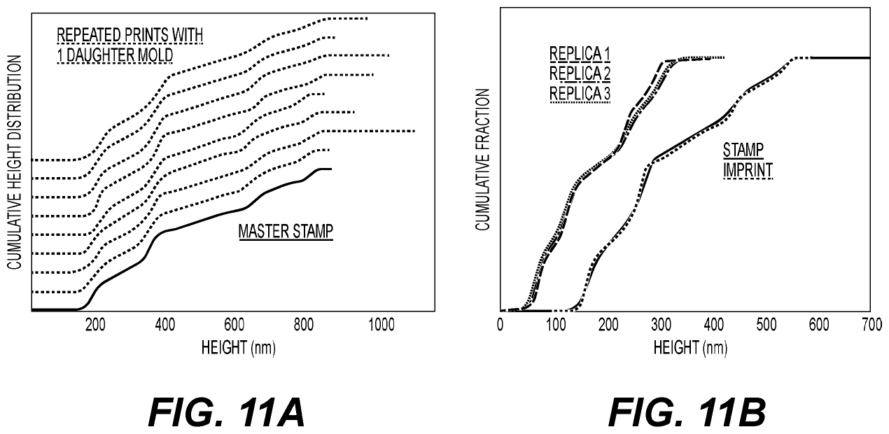

FIG. 11A provides a graph of cumulative height distribution for an embossing stamp as well as 8 imprints using the embossing stamp. As can be seen from the cumulative height distributions, the embossing stamp is able to consistently reproduce the pattern with good fidelity, demonstrating the ability of the stamp to retain the pattern after repeated imprints. FIG. 11B provides a graph of the cumulative height fraction for the stamp as well for an imprint in POSS resin made using the stamp and for three consolidated replicas. As can be seen from FIG. 11B, the imprint matches the stamp well, indicating a faithful reproduction of the stamp in the POSS resin. Further, the three consolidated replicas match each other as well as the general shape of the stamp and imprint. However, as result of consolidation the thickness of the film shrinks by about 50%.

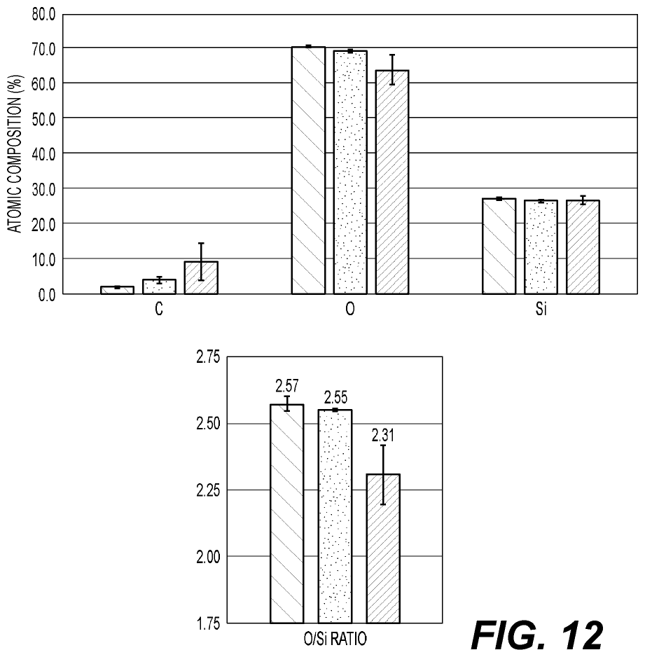

X-ray photodetection spectroscopy (XPS) analysis was performed on films of consolidated POSS films. In particular, FIG. 12 provides bar graphs of the percentage of carbon (C), oxygen (O), and silicon (Si) detected through XPS analysis. For each element, the left bar represents an unpatterned, consolidated POSS resin film having a thickness of 150 nm. The middle bar represents the consolidated, patterned POSS film, and the right bar is a control of fused silica fractured in air. As can be seen, atomic composition for the films are similar to the high purity fused silica control. FIG. 12 also provides a graph of the ratio (O/Si) of oxygen (O) to silicon (Si) after speciation of residual surface carbon. A ratio of O/Si>2 indicates adsorbed surface water. Both film and patterned samples contain higher O than high purity fused silica control, which may be due, at least in part, to residual porosity on the surface.

Additional samples POSS acrylate (MA0736 having acrylopropyl organic groups) were prepared as described in the Table below. The samples had different compositions, including different amounts of the following compounds: POSS resin (MA0736), trimethylolpropane triacrylate ((TMPTA) an acrylate crosslinker and plasticizer, Miwon Miramer M3130), 2-hydroxyethyl acrylate (HEA, monomer component), n-butyl polytitanate (Tyzor® BTP available from Dorf Ketal Chemicals (India) Pvt. Ltd., Mumbai, India), titanium acetylacetonates (Tyzor® AA available from Dorf Ketal Chemicals (India) Pvt. Ltd., Mumbai, India), photoinitiator (TPO-L), nanosilica particles (NANOPOL® C 764 available from Evonik Operations GmbH, Essen, Germany), and solvent (methoxypropanol). The particular POSS acrylate can be cured using either UV light or e-beam, but the samples were all cured using UV light.

TABLE 1
POSS Coating Compositions

| Composition 1 | Composition 2 | Composition 3 | Composition 4 |
|---|---|---|---|
| POSS | POSS | POSS | POSS |
| (85 wt %) | (42.5 wt %) | (42.5 wt %) | (26 wt %) |
| TMPTA | TMPTA | TMPTA | TMPTA |
| (9 wt %) | (5 wt %) | (5 wt %) | (3 wt %) |
| HEA | HEA | Tyzor BTP | Tyzor AA |
| (5 wt %) | (2.5 wt %) | (2.5 wt %) | (7 wt %) |
| TPO-L | Solvent | Solvent | Nanosilica |
| (1 wt %) | (49 wt %) | (49 wt %) | (26 wt %) |
| | TPO-L | TPO-L | Solvent |
| | (1 wt %) | (1 wt %) | (37.5 wt %) |
| | | | TPO-L |
| | | | (0.5 wt %) |
| Max. | Max. | Max. | Max. |
| Thickness | Thickness | Thickness | Thickness |
| ~200 nm | ~500 nm | ~850 nm | ~2000 nm |

All of the sample POSS resin films were deposited and consolidated at various different heating schedules up to 600 °C. Composition 1 did not include any separately added solvent, and the maximum thickness of the films after sintering was about 200 nm. Composition 2 included 49 wt % solvent, and the maximum thickness of the films after sintering was increased to about 500 nm. Composition 3 further included 2.5 wt % of n-butyl polytitanate, replacing the HEA monomer component, and the maximum thickness of the films after sintering was further increased to about 850 nm. Composition 4 included a different organotitanate compound in amount of 7 wt % as well as 26 wt % of nanosilica particles, and the maximum thickness of the films after sintering was substantially increased to 2000 nm. Thus, diluting the composition using a solvent, adding an organotitanate, and adding silica nanoparticles all contributed to increasing the film thickness as compared to using POSS resin alone.

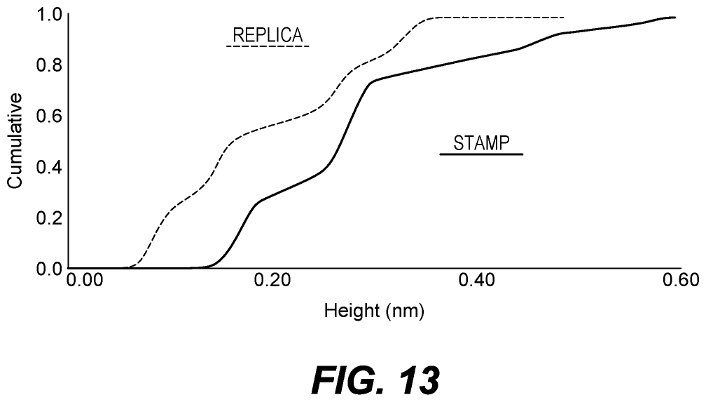

FIG. 13 provides a graph of cumulative height fractions for the stamp (“stamp”) as well as an imprint (“replica”). Here, the replica was formed as follows: a coating of Composition 4 was spin coated onto a glass sample at 3500 rpm for 30 seconds and then heated at 80 °C for 3 minutes; then, the nanoimprinter (NX-2500 available from Nanonex, Corp., Monmouth Junction, NJ) was used to imprint the texture of the stamp into the coating, as described above; afterwards, the imprinted coated was sequentially heated at 150 °C for 4 hours, 280 °C for 4 hours, and 600 °C for 2 hours with a heating ramp rate of 1 °C between these temperatures before being allowed to slowly cool to room temperature. The cumulative height fraction for the replica was measured after the heating sequence. As shown, the cumulative height fraction of replica has the same generally shape as the stamp with the same number of inflection points just shift towards lower heights. Consequently, the location of these inflection points can be directly compared to quantify the shrinkage (i.e., 100%*(Stamp-Replica)/Stamp), which is reported in Table 2. As shown, the shrinkage is less than 50% (e.g., less than 45%) for all of these measurements. Further, the trend is that larger features are associated with less shrinkage (going from inflection point 1 to inflection point 4). Overall, this shows that Composition 4 is able to achieve a shrinkage of less than 45% over a range of various feature sizes.

TABLE 2
Features of Cumulative Height Fractions in FIG. 13

| Inflection Point | Stamp (nm) | Replica (nm) | Shrinkage (%) |
|---|---|---|---|
| 1 | 180 | 100 | 44% |
| 2 | 290 | 165 | 43% |
| 3 | 465 | 275 | 42% |
| 4 | 585 | 350 | 40% |
| Plateau | 595 | 370 | 38% |

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations, and variations of the disclosed embodiments incorporating the spirit and substance of the embodiments may occur to persons skilled in the art, the disclosed embodiments should be construed to include everything within the scope of the appended claims and their equivalents.

What is claimed is:

1. A method of forming a glass article, the method comprising:
applying a coating comprising a precursor compound to at least a portion of a first major surface of a glass substrate;
imprinting a first texture into the coating; and
curing the coating to form a cured coating;
wherein the first texture defines surface features having lateral dimensions parallel to the first major surface of at least 1 μm and an average surface height of at least 50 nm; and
wherein the precursor compound comprises at least one of silicon, titanium, or zirconium and the cured coating comprises an oxide, nitride, or oxynitride of the at least one of silicon, titanium, or zirconium.

2. The method of claim 1, wherein the coating comprises a filler comprising at least one of colloidal silica, fumed silica, precipitated silica, silica gel, glass fiber, glass beads colloidal zirconia, colloidal titania, colloidal alumina, or nano-crystalline materials.

3. The method of claim 1, wherein the coating further comprises a flow aid configured to decrease a viscosity of the coating, wherein the flow aid comprises at least one of liquid paraffin wax, hexadecane, methyl oleate, alkanes having a chain length of at least 10 carbons, fatty acids, fatty acid esters, hydroxyethyl methacrylate, or bisphenol A dimethacrylate.

4. The method of claim 1, wherein the coating further comprises at least one of an organotitanate, an organozirconate, or an organoborate.

5. The method of claim 1, wherein the curing further comprises exposing the coating to ultraviolet light.

6. The method of claim 5, wherein the imprinting and the curing are performed simultaneously using nanoimprinting lithography.

7. The method of claim 1, wherein the curing further comprises exposing the coating to a temperature of at least 350 °C for a time of at least 30 mins.

8. The method of claim 1, wherein the curing further comprises providing the coating with a base catalyst and exposing the coating to a temperature in a range from 100 °C to 200 °C.

9. The method of claim 1, further comprising consolidating the cured coating by heating cured coating to a temperature in a range of 500 °C to 1000 °C.

10. The method of claim 1, wherein the precursor compound comprises at least one of hydridosilsesquioxane, polyhedral silsesquioxane, or oligomeric silsesquioxanes.

11. The method of claim 10, wherein the cured coating comprises amorphous silica.

12. The method of claim 1, wherein the first major surface of the glass substrate comprises an etched surface having a second texture and the coating modifies the second texture based on the first texture.

13. The method of claim 1, wherein after curing or consolidating, the method further comprises the steps of:
applying a second coating comprising a second precursor compound to at least a portion of the cured or consolidated coating;
imprinting a second texture into the second coating; and
curing the second coating to form a second cured coating;
wherein the second texture modifies the first texture.

14. The method of claim 1, wherein imprinting the coating further comprises pressing a stamp into the coating at a pressure in a range from 10 psi to 120 psi for a time of up to 10 mins at a temperature in a range of 20 °C to 200 °C.

15. The method of claim 1, wherein the cured coating is an antiglare coating, wherein the antiglare coating comprises a sparkle of 7% or less (PPD-140), a haze of 20% or less, a distinctiveness of image of less than 90 as measured using SMS-100, and a specular reflectance of 2% or less.

16. The method of claim 1, wherein the imprinting further comprises stamping or rolling the first texture into the precursor compound.

17. The method of claim 1, wherein the precursor compound further comprises at least one monomer component in an amount up to 20 wt %.

18. The method of claim 17, wherein the at least one monomer component comprises at least one of 2-hydroxyethyl acrylate or trimethylolpropane ethoxylate triacrylate.

19. A glass article, comprising:
a glass substrate comprising a first major surface, a second major surface, and a minor surface, the second major surface being opposite to the first major surface, and the minor surface extending between the first major surface and the second major surface around a periphery of the glass substrate; and
a coating disposed on the first major surface;
wherein a first texture is imprinted into at least a portion of the coating, the first texture defines surface features having lateral dimensions parallel to the first major surface of at least 1 μm and an average surface height of at least 50 nm;
wherein the glass substrate comprises a first composition and the coating comprises a second composition, the first composition and the second composition being different; and
wherein the coating comprises an oxide, nitride, or oxynitride of at least one of silicon, titanium, or zirconium.

20. A glass article, comprising:
a glass substrate comprising a first major surface, a second major surface, and a minor surface, the second major surface being opposite to the first major surface, and the minor surface extending between the first major surface and the second major surface around a periphery of the glass substrate; and
a coating disposed on the first major surface;
wherein a first texture is imprinted into at least a portion of the coating, the first texture defines surface features having lateral dimensions parallel to the first major surface of at least 1 μm and an average surface height of at least 50 nm;
wherein the coating comprises a coating composition having a chemical formula of SiOₓ in which x is in a range of 1.8 to 2.2; and
wherein the glass substrate comprises a glass composition, the glass composition being different from the coating composition.
